(19) United States
(12) Patent Application Publication
(10) Pub. No.: US 2016/0033070 A1
(43) Pub. Date: Feb. 4, 2016

(54) RECURSIVE PUMPING MEMBER

(71) Applicant: Applied Materials, Inc., Santa Clara, CA (US)

(72) Inventors: Paul BRILLHART, Pleasanton, CA (US); Edric TONG, Sunnyvale, CA (US); Anzhong CHANG, San Jose, CA (US); David K. CARLSON, San Jose, CA (US); Errol Antonio C. SANCHEZ, Tracy, CA (US); James Francis MACK, Woodside, CA (US); Kin Pong LO, Fremont, CA (US); Zhiyuan YE, San Jose, CA (US)

(21) Appl. No.: 14/550,723

(22) Filed: Nov. 21, 2014

Related U.S. Application Data
(60) Provisional application No. 62/032,425, filed on Aug. 1, 2014.

(51) Int. Cl. F16L 55/00

(52) U.S. Cl. CPC F16L 55/00

(57) ABSTRACT

Embodiments of the disclosure relate to a perimeter pumping member for a processing chamber. The perimeter pumping member comprises a ring-shaped body having a first curved channel along an arc within the ring-shaped body, a first inner channel connecting a first region of the first curved channel to a first region of an inner surface of the ring-shaped body, a plurality of second inner channels connecting a second region of the first curved channel to a second region of the inner surface, and a first outer channel connecting the first region of the first curved channel to an outer surface of the ring-shaped body, wherein the second inner channels are each sized such that, when a fluid is pumped out of the perimeter pumping member via the first outer channel, the fluid flows through the first inner channel and the second inner channels at a uniform flow rate.

### CROSS-REFERENCE TO RELATED APPLICATIONS

This application claims benefit of U.S. provisional patent application Ser. No. 62/032,425, filed Aug. 1, 2014, which is herein incorporated by reference.

### BACKGROUND

1. Field

Embodiments described herein generally relate to apparatus and methods for improving gas flow within a semiconductor processing chamber. More specifically, embodiments described herein relate to a recursive pumping member.

2. Description of the Related Art

In semiconductor processing, various processes are commonly used to form films that have functionality in a semiconductor device. Among those processes are certain types of deposition processes referred to as epitaxy. In an epitaxy process, a gas mixture is typically introduced in a chamber containing one or more substrates on which an epitaxial layer is to be formed. Process conditions are maintained to encourage the vapor to form a high quality material layer on the substrate. Epitaxy is generally favored when high quality and uniformity of a film deposited across the surface of a substrate are desired.

In an exemplary epitaxy process, a material such as a dielectric material or semiconductor material is formed on an upper surface of a substrate. The epitaxy process grows a thin, ultra-pure material layer, such as silicon or germanium, on a surface of the substrate. The material may be deposited in a lateral flow chamber by flowing a process gas substantially parallel to the surface of a substrate positioned on a support, and by thermally decomposing the process gas to deposit a material from the gas onto the substrate surface.

Processing uniformity is generally desired in the semiconductor industry, and much research and development effort is devoted to improving processing uniformity throughout the semiconductor fabrication process. Reactor design, for example, gas flow patterns, and temperature control apparatus can affect film quality and uniformity in epitaxial growth. Since gas flow characteristics can impact the film performance on the substrate, there is a need for a gas delivery and deposition apparatus which facilitates growth of a uniform material layer on the substrate.

Cross-flow gas delivery apparatuses inject gas into the processing chamber such that the gas flows laterally across the surface of the substrate while the substrate is rotated. However, center to edge non-uniformities of the deposited film may result due to uneven gas flow characteristics. In some cases, the type and number of precursor species that may be introduced via the cross-flow gas delivery apparatus are difficult to control in terms of matching timing of cracking with gas delivery to the surface of the substrate.

Thus, there is a need in the art for improved gas flow apparatus for epitaxy processes.

FIG. 1 illustrates a schematic, cross-sectional view of a process chamber 100. The process chamber 100 and the associated hardware are preferably formed from one or more process-compatible materials, such as stainless steel, quartz (e.g., fused silica glass), SiC, CVD-coated SiC over graphite (30-200 microns), and combinations and alloys thereof, for example.

The process chamber 100 is used to process one or more substrates, including the deposition of a material on an upper surface 116 of a substrate 108. The process chamber 100 comprises a chamber body member 100a, a first divider 114, and a second divider 128 which define a processing volume 156. Each divider 114, 128, may be a quartz dome. A base ring 136, which is disposed between a first clamp ring 101 and a second clamp ring 130, separates the first divider 114 and the second divider 128. A liner assembly 163 is positioned inside the base ring 136, and a preheat ring 167 is positioned adjacent to the liner assembly 163. The preheat ring 167 extends radially inward from the liner assembly 163 to shield excess radiation from propagating beyond the preheat ring 167 and to preheat incoming process gases before the process gases contact the upper surface 116 of the substrate 108. A reflector plate 122 is disposed adjacent to the second divider 128 outside the processing volume 156, and the reflector plate 122 is coupled to the second clamp ring 130.

A lamp array 145 may be coupled to the first clamp ring 101 adjacent the first divider 114. The lamp array 145 includes one or more lamps 102, each lamp 102 having a bulb 141. The lamp array 145 may be configured to heat the substrate 108 to a desired temperature over a relatively short period of time. The heating process may include repetitive heating and cooling cycles to achieve desirable material properties deposited on the upper surface 116 of the substrate 108 in an embodiment. In other embodiments, the heating process may be used as a bake on the upper surface 116. The lamp array 145 also provides for independent control of the temperature at various regions of the substrate 108, thereby facilitating the deposition of a material onto the upper surface 116 of the substrate 108. One or more temperature sensors 118 may be optionally coupled to the chamber 100 via the reflector plate 122 or coupled through the lamp array 145. The temperature sensors 118, each of which may be a pyrometer, may be configured to measure temperatures of one or more of the substrate 108, a substrate support 106, second divider 128, or a first divider 114 by receiving radiation (e.g., emitted from the substrate 108 through the second divider 128) and comparing the received radiation to a temperature-indicating standard.

The substrate support 106 is disposed within the processing region 156 of the process chamber 100. The substrate support 106, together with the second divider 128, bounds the processing region 156, and a purge gas region 158 is opposite the substrate support 106 from the processing region 156. The substrate support 106 may be rotated during processing by a central shaft 132 to minimize the effect of thermal and process gas flow spatial anomalies within the process chamber 100. The substrate support 106 is supported by the central shaft 132, which may move the substrate 108 in an axial direction 134 during loading and unloading, and in some instances, during processing of the substrate 108.

The reflector plate 122 is placed outside the second divider 128 to reflect infrared light that is radiating off the substrate 108 during processing back onto the substrate 108. The reflector plate 122 can be made of a metal, such as aluminum or stainless steel. The efficiency of the reflection can be improved by coating the reflector plate 122 with a highly reflective coating, such as gold, or by polishing the reflector plate 122 to improve the reflectivity. In one embodiment, a selective coating which is tuned for specific wavelengths may be disposed on the reflector plate in selected regions. In this embodiment, the selective coating may enhance low temperature pyrometer 118 accuracy and repeatability. In another embodiment, the reflector plate 122 may absorb light and may be coated with a light absorbing material to improve radiative cooling and thermal uniformity of the chamber 100.

The reflector plate 122 can have one or more channels (not shown), which may be machined, connected to a cooling source (not shown). The channels connect to a passage (not shown) formed on a side of the reflector plate 122. The passage is configured to carry a flow of a fluid, such as water, for cooling the reflector plate 122. The passage may run along the side of the reflector plate 122 in any desired pattern covering a portion or entire side of the reflector plate 122. In another embodiment, the reflector plate 122 may be coupled to a fluid source which is configured to heat the reflector plate 122. The fluids which may be flowed through the passage include various heating or cooling fluids, such as a deionized water and glycol mixture or an inert fluorinated liquid.

Process gas supplied from a process gas supply source 172 may be introduced into the processing region 156 through a process gas inlet 174 formed in the sidewall of the base ring 136. The process gas inlet 174 may be configured to direct the process gas in a generally radially inward direction and may be tuned by the use of zones to enable improved center to edge uniformity. During the film formation process, the substrate support 106 may be located in the processing position, which is adjacent to and at about the same elevation as the process gas inlet 174. In this arrangement, the process gas flows up and around approximately along flow path 173 across the upper surface 116 of the substrate 108 in a quasi laminar flow fashion.

The process gas and effluent gas exit the process gas region 156 (approximately along flow path 175) through a gas outlet 178 located on the side of the process chamber 100 opposite the process gas inlet 174. The process gas inlet 174 and the gas outlet 178, which are approximately aligned with the plane of the substrate 108 upper surface 116, may be aligned to each other and disposed approximately at the same elevation to facilitate the quasi laminar flow of process gas across the substrate 108. In one embodiment, the process gas inlet 174 and gas outlet 178 may be disposed at a first elevation radially inward of the liner assembly 163, however, the process gas inlet 174 and gas outlet 178 may be in a second plane, which may be lower than the first plane, radially outward of the liner assembly 163. Removal of the process gas through the gas outlet 178 may be facilitated by a vacuum pump 180 coupled to the gas outlet 178. To further increase deposition uniformity, the substrate 108 may be rotated by the substrate support 106 during processing.

### SUMMARY

In one embodiment, a perimeter pumping member for a processing chamber is provided. The perimeter pumping member generally includes a ring-shaped body having a first curved channel along an arc within the ring-shaped body, a first inner channel connecting a first region of the first curved channel to a first region of an inner surface of the ring-shaped body, a plurality of second inner channels connecting a second region of the first curved channel to a second region of the inner surface, and a first outer channel connecting the first region of the first curved channel to an outer surface of the ring-shaped body, wherein the second inner channels are each sized such that, when a fluid is pumped out of the perimeter pumping member via the first outer channel, the fluid flows through the first inner channel and the second inner channels at a uniform flow rate.

In another embodiment, an apparatus for processing a substrate is provided. The apparatus generally includes a processing chamber body, a divider coupled to the chamber body, one or more holes formed through the divider, which may be a dome, one or more conduits, each of which has a first end and a second end, and each of which may be a tube, coupled to the divider at the first end, each conduit extending from one of the one or more holes, a flangecoupled to the second end of each of the one or more conduits, and a perimeter pumping member coupled within the chamber body. The perimeter pumping member generally includes a ring-shaped body having a first curved channel along an arc within the ring-shaped body, a first inner channel connecting a first region of the first curved channel to a first region of an inner surface of the ring-shaped body, a plurality of second inner channels connecting a second region of the first curved channel to a second region of the inner surface, and a first outer channel connecting the first region of the first curved channel to an outer surface of the ring-shaped body, wherein the second inner channels are each sized such that, when a fluid is pumped out of the perimeter pumping member via the first outer channel, the fluid flows through the first inner channel and the second inner channels at a uniform flow rate.

In yet another embodiment, an apparatus for processing a substrate is provided. The apparatus generally includes a processing chamber body, a first quartz divider, which may be a dome, coupled to the chamber body, a second quartz divider, which may be a dome, coupled to the chamber body opposite the first quartz divider, the chamber body, first quartz divider, and second quartz divider defining a processing volume, a substrate support disposed within the processing volume, a lamp array coupled to the chamber body outside the processing volume, one or more holes formed through the second quartz divider, a conduit, which may be a tube, coupled to each of the one or more holes and extending from each hole away from the processing volume, a flangecoupled to each conduit, and a perimeter pumping member coupled within the chamber body. The perimeter pumping member generally includes a ring-shaped body having a first curved channel along an arc within the ring-shaped body, a first inner channel connecting a first region of the first curved channel to a first region of an inner surface of the ring-shaped body, a plurality of second inner channels connecting a second region of the first curved channel to a second region of the inner surface, and a first outer channel connecting the first region of the first curved channel to an outer surface of the ring-shaped body, wherein the second inner channels are each sized such that, when a fluid is pumped out of the perimeter pumping member via the first outer channel, the fluid flows through the first inner channel and the second inner channels at a uniform flow rate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic, cross-sectional view of a processing chamber.

FIG. 2 illustrates a top perspective view of a processing chamber according to one embodiment described herein.

FIG. 3 illustrates a perspective view of internal chamber components with a chamber body removed according to one embodiment described herein.

FIG. 4A illustrates a cross-sectional view of a gas delivery apparatus according to one embodiment described herein.

FIG. 4B illustrates a cross-sectional view of a gas delivery apparatus according to one embodiment described herein.

FIG. 5 illustrates a perspective view of a divider, conduits, and flanges according to one embodiment described herein.

FIG. 6 illustrates a perspective view of a divider, according to one embodiment described herein.

FIG. 7 illustrates a plan view of the divider and flanges of FIG. 5.

FIG. 8 illustrates a perspective view of a perimeter pumping member according to one embodiment described herein.

FIG. 9 illustrates a perspective view of a perimeter pumping member according to one embodiment described herein.

FIG. 10 illustrates a perspective view of a perimeter pumping member according to one embodiment described herein.

FIG. 11 illustrates a perspective view of a perimeter pumping member according to one embodiment described herein.

FIG. 12 illustrates a perspective view of a lower liner according to one embodiment described herein.

FIG. 13 illustrates a cross-sectional view of a processing chamber with a perimeter pumping member and a lower liner according to one embodiment described herein.

FIG. 14 illustrates a cross-sectional view of a processing chamber with a perimeter pumping member and a lower liner according to one embodiment described herein.

FIG. 15 is a flow diagram summarizing an operation for processing substrates in a process chamber, according to aspects of the present invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments provided herein generally relate to an apparatus for delivering gas to and removing gas from a semiconductor processing chamber. A divider, which may be a quartz dome, flat window, or showerhead, of an epitaxial semiconductor processing chamber may have a plurality of holes formed therein and precursor and carrier gases may be provided into a processing volume of the chamber through the holes of the divider, window, or showerhead. Gas delivery conduits, each of which may be a tube, may extend from the holes of the divider to one or more flanges where the conduits may be coupled to gas delivery lines. Such gas delivery apparatus (e.g., gas delivery conduits, flanges, and gas delivery lines) enables gases to be delivered to the processing volume above a substrate through the divider. A pumping member may have a plurality of channels formed therein, and effluent and process gases may be removed from the processing volume of the chamber through the channels. The pumping member enables gases to be removed from the processing volume in substantially radial directions at uniform flow rates (e.g., a flow rate in any channel is within +/−20% of an average of flow rates for all of the channels) along the perimeter of the processing volume.

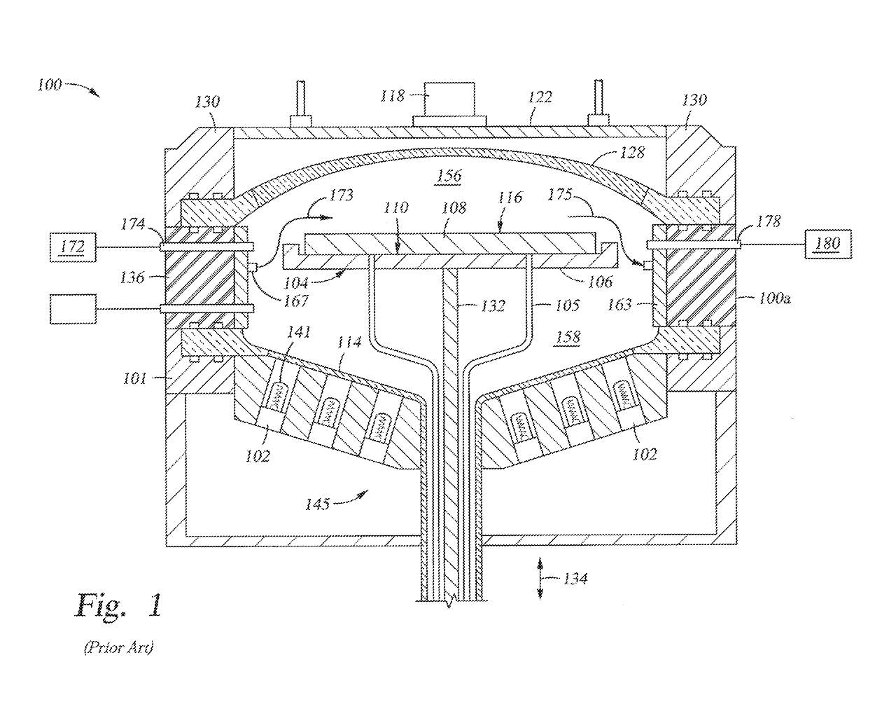

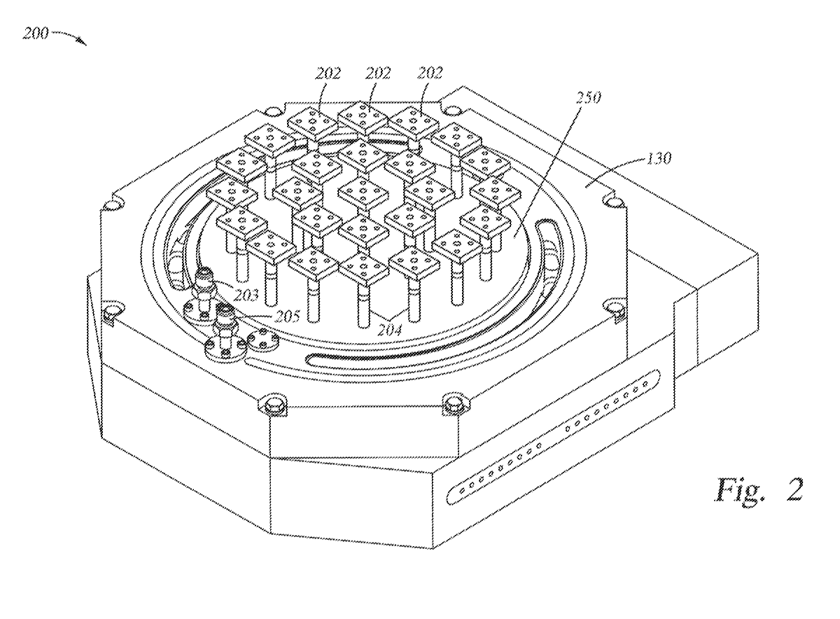

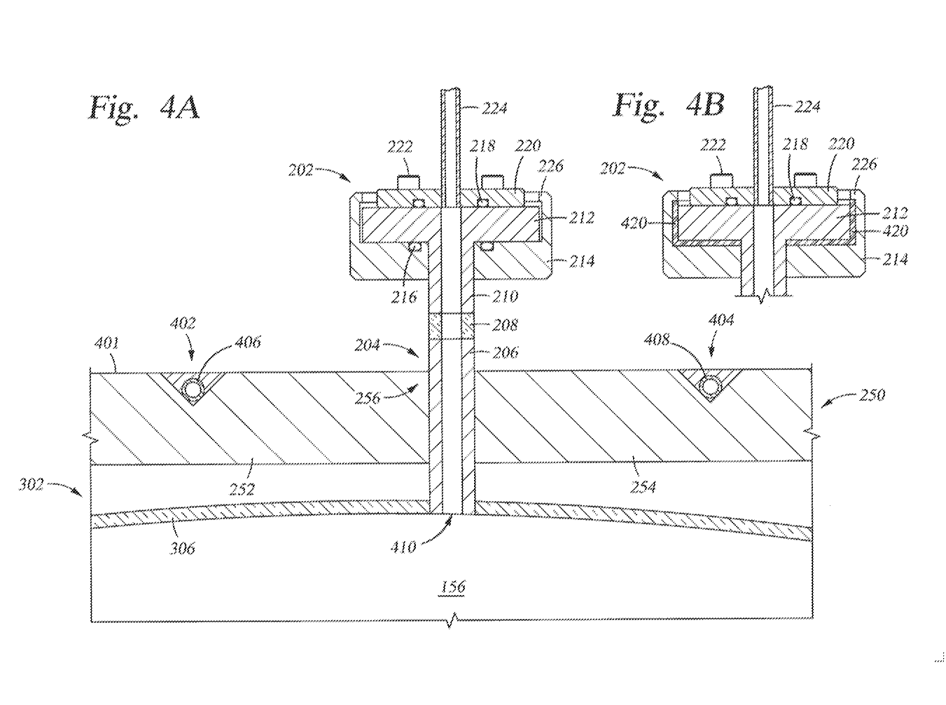

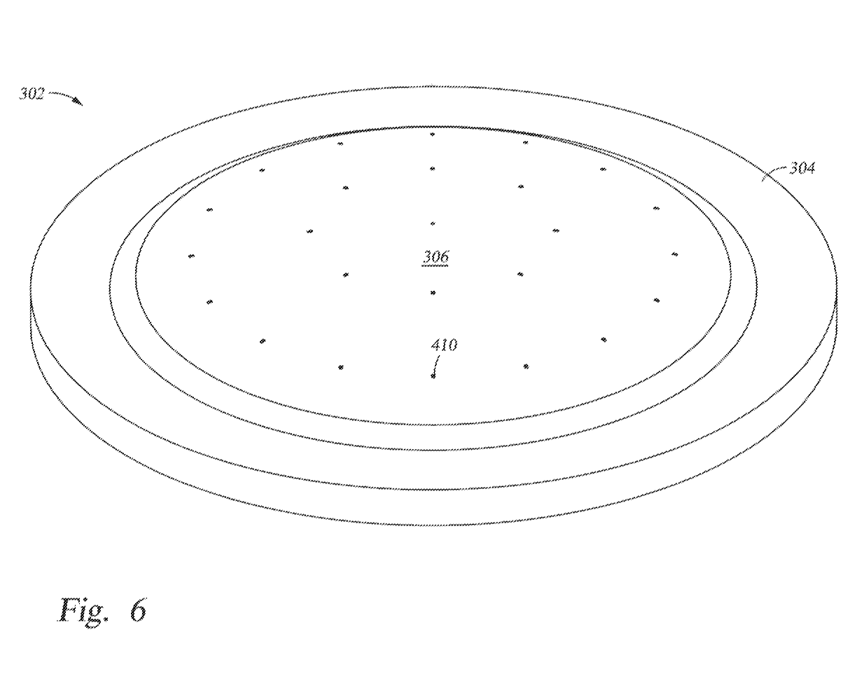

FIG. 2 illustrates a top perspective view of a processing chamber 200. Aspects of the processing chamber 200 which are similar to the chamber 100 of FIG. 1 have been discussed in greater detail above. The chamber 200 includes a plurality of gas injection assemblies 202 and a reflector plate 250. The gas injection assemblies 202 are configured to provide processing gas through a second divider (not shown in FIG. 2, see FIGS. 6-9) of the processing chamber 200. While twenty-five gas injection assemblies 202 are shown, other numbers of gas injection assemblies are contemplated. Also, while the gas injection assemblies 202 are shown arranged in two concentric circles, other arrangements (e.g., spiral, multiple spiral arms, and at a plurality of distances from the center in a non-spiral pattern) are contemplated. Gas delivery conduits 204 (see, also, FIGS. 4-6) extend from the second divider to the injection assemblies 202 through the reflector plate 250. The reflector plate 250 is coupled to the second clamp ring 130 above the second divider. The reflector plate 250 generally shields the injection assemblies 202 from radiation that passes through the second divider. One or more temperature sensors, any of which may be a pyrometer, (not shown in FIG. 2) are coupled through the reflector plate 250 to view the substrate through the second divider. A coolant inlet port 203 and coolant outlet port 205 are provided to supply the second clamp ring 130 with a coolant fluid.

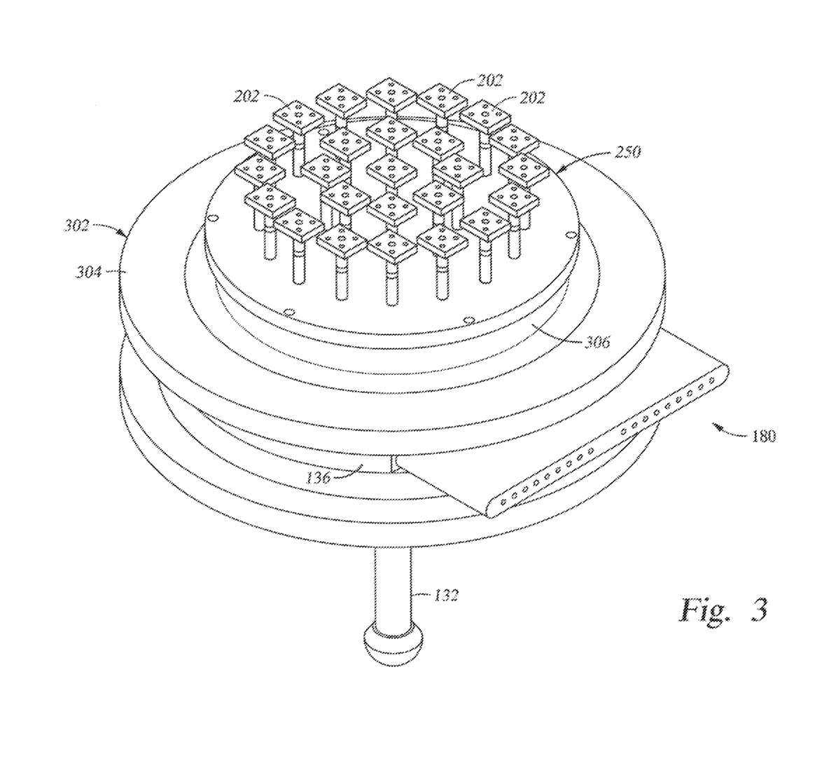

FIG. 3 illustrates a perspective view of internal chamber components of the processing chamber 200. As depicted, the first clamp ring 101 (FIG. 1) and the second clamp ring 130 (FIGS. 1 and 2) are removed to expose the interior of the chamber 200. The central shaft 132 is coupled to the substrate support 106 (FIG. 1). As process gas flows down to and across the top surface 116 of the substrate 108, the process gas exits the processing region 156 (FIG. 1) via the process gas outlet 180. The gas injection assemblies 202, which deliver process gas to the processing region 156 from above the substrate 108, enable a degree of flexibility when processing the substrate 108.

In one embodiment, various precursors, such as Group III and Group V precursors, may be flowed from the gas injection assemblies 202 down to and across the substrate 108. Precursors of different groups may be flowed together or at separate times through the gas injection assemblies 202. It is believed that gas provided from the gas injection assemblies 202 allows for a shorter path of travel to the substrate 108, which also increases the gas concentration at the surface 116. It is believed that the increased gas concentration may enhance nucleation at the surface 116 of the substrate 108. As a result, a more uniform crystal structure of the deposited layer may be obtained and a reduction in processing time may be realized, in comparison to other processing chambers. In addition, the shorter flow path may prevent premature gas species cracking (molecular splitting), thus increasing overall gas utilization.

A second divider 302 is disposed above and coupled to the base ring 136. The second divider 302 may be formed from a light transmissive material, such as quartz. The second divider 302 comprises an outer region 304 and an inner region 306. The outer region 304 is the portion of the second divider 302 that is coupled to the base ring 136 while the inner region 306 may have a mostly curved profile that at least partially defines the processing volume 156. In one example, the inner region 306 of the second divider 302 is light transmissive and the outer region 304 is primarily opaque. The inner region 306 has one or more holes formed therein (see FIGS. 4A and 6) which enable gas delivery to the processing volume 156 through the second divider 302.

In one example, the outer surface of the inner region 306 of the second divider 302 is coated with a reflective material (e.g., gold or silver plating) to form a reflective surface located outside of the processing volume 156. Portions of the outer surface of the second divider may not be coated with the reflective material, allowing temperature sensors (e.g., pyrometers) or other equipment to have a view of the interior of the processing chamber 200. A processing chamber using a second divider 302 coated with a reflective material may not use a reflector plate 122 (see FIG. 1) or 250 (see FIG. 2).

The reflector plate 250 is disposed above the inner region 306 of the second divider 302 between the injection assemblies 202 and the second divider 302. As such, the reflector plate 250 may be circular in shape and may be sized similarly to the inner region 306 of the second divider 302. The reflector plate 250 is formed from a thermally stable metallic material, such as aluminum or stainless steel. The reflector plate 250 may be plated (e.g., gold or silver plated) or highly polished to improve the reflectivity of the reflector plate 250 that faces the second divider 302. A thickness of the reflector plate may be between about ¼ inch and about ¾ inch, such as between about ⅜ inch and about ½ inch.

The reflector plate 250 may be configured to accommodate the gas tubes extending through the reflector plate 250. For example, the reflector plate 250 may have circular or elliptical shaped holes 256 (see FIG. 4A) to allow for the passage of the gas tubes. To reduce the incidence of light propagation through the holes 256, any space between the conduits 204 and the holes 256 may be filled with a thermally stable, radiation blocking material, such as Teflon or the like. The holes 256 may be any shape that accommodates passage of the conduits 204 through the reflector plate 250 while facilitating light isolation in the processing region 156. Square shaped or rectangular shaped holes, curved square holes or curved rectangular holes, and other similar shapes are contemplated. Light isolation for such shapes may be achieved using the fillers described above.

FIG. 4A illustrates a cross-sectional view of a gas injection assembly 202. The injection assembly 202 comprises the conduit 204, which extends from a hole 410 of the second divider 302 to a flange 212. The conduit 204 defines a channel or void such that the processing region 156 is in fluid communication with the flange 212. The flange 212 is surrounded by a coupling member 214. A gas delivery line 224, which aligns with the conduit 204, may be coupled to the flange 212 via a mounting plate 220. The mounting plate 220 may be secured to the coupling member 214 by one or more fasteners 222, such as bolts or screws, through the flange 212. The flange 212 may be separated from the coupling member 214 by a plurality of spacers 216 (e.g., o-rings) and the flange 212 may be separated from the mounting plate 220 by a plurality of sealing spacers 218 (e.g., o-rings). The spacers 216 and sealing spacers 218 may comprise a polymer material, such as a compliant material or an elastomeric material, and may operate to prevent physical contact between the flange 212, coupling member 214 and mounting plate 220.

In one embodiment, the flange 212 may be formed from a quartz material and the coupling member 214, mounting plate 220, and fasteners 222 are formed from a metallic material, such as stainless steel, aluminum, or alloys thereof. A lip 226 of the coupling member 214 may extend above a top surface of the flange 212. As such, a cross-sectional profile of the coupling member 214 may be U-shaped. The delivery line 224 extends from the flange 212 to a gas source (not shown). The gas source may deliver various processing gases and other gases to the processing region 156 via the injection assembly 202. For example, Group III, Group IV, and Group V precursors and combinations thereof may be provided by the gas source.

The conduit 204 is coupled between the upper dome 302 and the flange 212. The conduit comprises a first conduit member 206, a second conduit member 210, and a spacer 208 between the first conduit member 206 and the second conduit member 210. The first conduit member 206 is aligned with the hole 410 such that the first conduit member 206 extends away from the hole 410. In one embodiment, the first conduit member 206 may extend from the hole 410 in a vertical direction or, alternatively, at an angle. The first conduit member 206 may be coupled to the second divider 302 by a quartz weld or other bonding method, such as diffusion bonding. The hole 410 may be circular in shape and may be normal to a plane occupied by the conduit 204 where the hole 410 extends through the second divider 302. However, the hole 410 may be shapes other than circular, such as oval shaped or square shaped. Moreover, it is contemplated that the hole 410 may be angled through the second divider 302 in an orientation other than normal to the plane occupied by the conduit 204. In one embodiment, the conduit 204 may extend beyond the second divider 302 into the processing volume 156 towards the substrate 108 (not shown).

The first conduit member 206 and the second conduit member 210 may each comprise a quartz material that is light transmissive, however, it is contemplated that the first conduit member 206 and second conduit member 210 may also be formed from a radiation blocking material, such as black quartz or bubble quartz. The spacer 208 may be coupled between the first conduit member 206 and the second conduit member 210 by a quartz weld or similar bonding method. The spacer 208 may be a thermal break comprising an at least partially opaque quartz material, such as bubble quartz. The partially opaque quartz material, which has a greater degree of opacity than the light transmissive quartz of the first conduit member 206 and the second conduit member 210, reduces or prevents the propagation of light energy through the conduit 204. As such, light that enters the first conduit member 206 is prevented from propagating beyond the spacer 208 to the second conduit member 210 and the flange 212 in an embodiment where the spacer 208 is a thermal break. The spacer 208 is disposed between the first conduit member 206 and the second conduit member 210 above the reflector plate 250. In one embodiment, the spacer 208 may be omitted, and in such an embodiment only the clear quartz of the first conduit member 206 and the second conduit member 210 form the conduit 204.

A first channel 402 and a second channel 404 are formed in the reflector plate 250. While two channels are present in the depicted embodiment, other numbers of channels are contemplated. The first channel 402 and the second channel 404 are V-shaped or U-shaped recesses formed in a surface 401 of the reflector plate 250 facing away from the processing region 156. A first cooling conduit 406 may be disposed within the first channel 402 and a second cooling conduit 408 may be disposed within the second channel 404. The cooling conduits 406 and 408 may be tubular in shape and may follow the path of the first and second channels 402 and 404, respectively. In one embodiment, a depth of the channels 402 and 404 may be greater than a diameter of the conduits 406 and 408. In such cases, the conduits 406 and 408, when disposed within the channels 402 and 404, are located below the surface 401 of the reflector plate 250.

FIG. 4B illustrates a cross-sectional view of a gas injection assembly 202, according to one embodiment. In this embodiment, a compliant member 420 is disposed between the flange 212 and the coupling member 214. The compliant member 420 is formed from an elastomeric material or a vulcanized rubber, and functions to prevent physical contact between the flange 212 and the coupling member 214. The compliant member 410 may be a single sheet of material or may be sprayed onto either the flange 212 or the coupling member 214. Portions of the compliant member 420 may be counter-sunk where the fasteners 222 or conduits 204 extend through the compliant member 410 to ensure continuous contact between the compliant member 420 and the flange 212 or the coupling member 214.

In the embodiment described above, twenty-five holes 410 are formed through the inner region 306 where the conduits 204 are coupled to the second divider 302. It is contemplated that a greater number or lesser number of holes 410 and conduits 204 may be utilized to more finely tune the delivery of process gases through the second divider 302. In one embodiment, the first conduit member 206, the spacer 208, and the second conduit member 210 have similar inner diameters and outer diameters. For example, the inner diameter is between about 5 mm and about 15 mm, such as about 10 mm. The outer diameter is between about 10 mm and about 20 mm, such as about 16 mm. As such, a thickness of the conduit 204 walls is between about 1 mm and about 3 mm, such as about 2 mm.

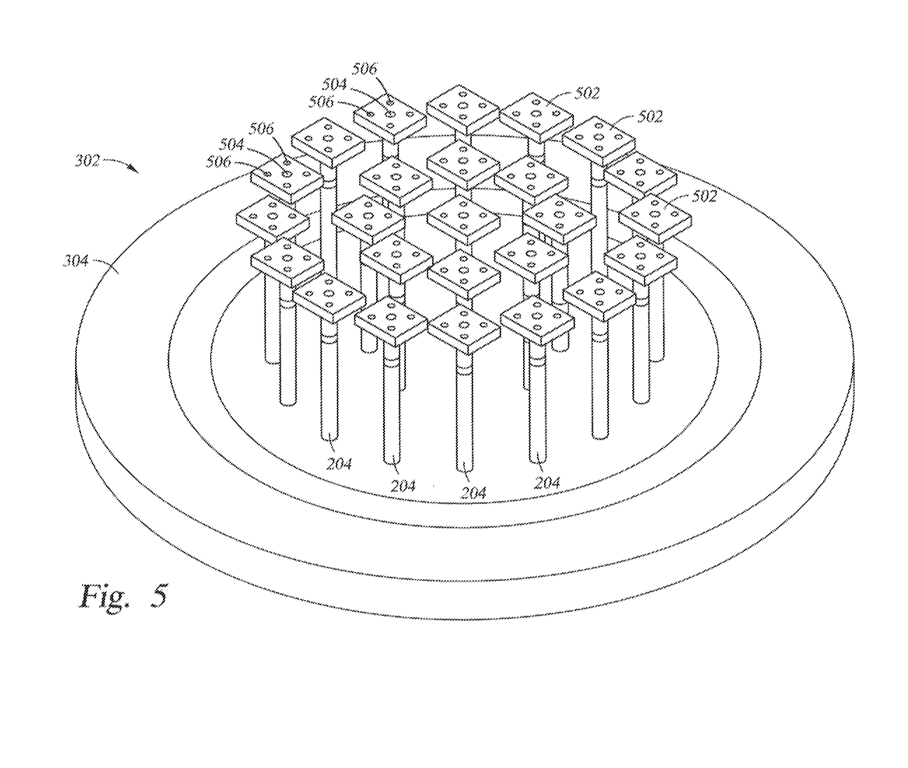

FIG. 5 illustrates a perspective view of the second divider 302, conduits 204, and flanges 502. Each of the flanges 502 may be separated from adjacent flanges. For example, each of the flanges may be separated from adjacent flanges by a distance ranging from 0.5 mm to 25 mm. As such, each of the conduits 204 may be coupled to a different flange 502. Although twenty-five conduits 204 and flanges 502 are depicted, it is contemplated that any number of tubes may be utilized and the number of flanges may be matched to the number of tubes.

As depicted, each of the flanges 502 may include one of the first plurality of holes 504 and four of the second plurality of holes 506, although other hole arrangements are possible. In one embodiment, flanges 502 may have a quadrilateral shape, for example, square-like or rectangular. In other embodiments, flanges may have other shapes, for example, round. As described above, each of the flanges 502 remain spaced apart from adjacent flanges. Thus, thermal influences on each of the flanges 502 affect only an individual flange and the influence on adjacent flanges is reduced or eliminated. For example, radiant energy transmitted to a flange 502 via a conduit 204 may heat one flange differently than the remaining flanges. Because the flanges 502 are spatially isolated from one another, thermal effects may be eliminated, reduced, or localized to a single flange.

FIG. 6 illustrates a perspective view of a second divider 302. As described above, the outer region 204 of the second divider may be formed of an opaque material, while the inner region 306 may be formed of a light transmissive material. Also as described above, portions of the upper surface of the inner region 306 may be coated with a reflective coating (e.g., silver or gold plating). In the embodiment illustrated, twenty-five holes 410 are formed through the inner region 306 where the conduits 204 are connected to the second divider 302 (see FIG. 5). It is contemplated that a greater or lesser number of holes 410 and conduits 204 may be utilized to more finely tune the delivery of process gases through the second divider 302. While the holes 410 illustrated are arranged in concentric circles, other arrangements (e.g., spiral, multiple spiral arm, and at a plurality of distances from the center in a non-spiral pattern) are contemplated. In one embodiment, the diameter of each of the holes 410 is between about 10 mm and 20 mm, such as about 16 mm.

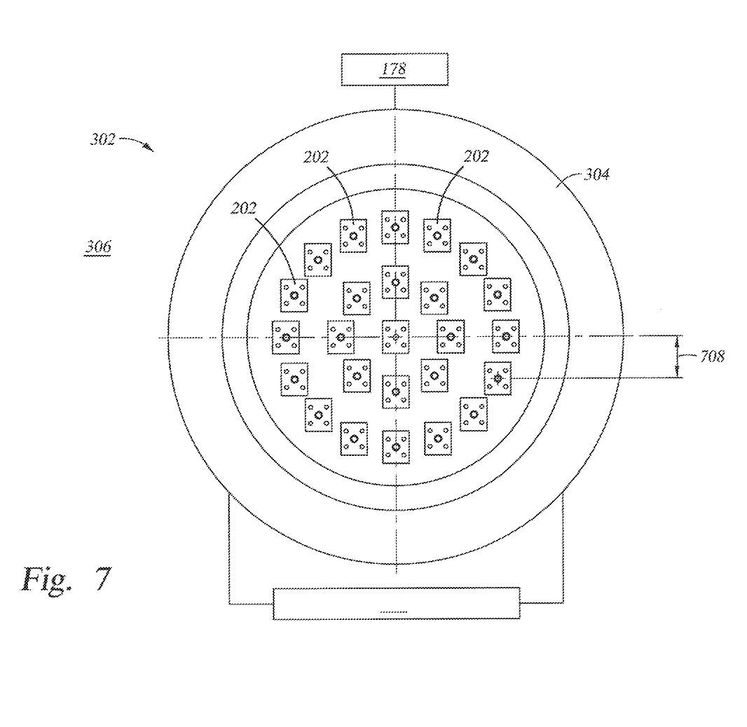

FIG. 7 illustrates a top view of the second divider 302 and gas injection assemblies 202 of FIG. 5. As previously described, the spacing and arrangement of gas injection assemblies 202 may be configured to mitigate undesirable thermal consequences of a unitary flange. A space 708 separating each gas injection assembly from an adjacent gas injection assembly may extend a distance of between about 10 mm and about 30 mm, such as between about 15 mm and about 25 mm, for example, about 21.5 mm. It is to be noted that the arrangement of gas injection assemblies 202 shown in FIG. 7 is one example, and other arrangements are contemplated.

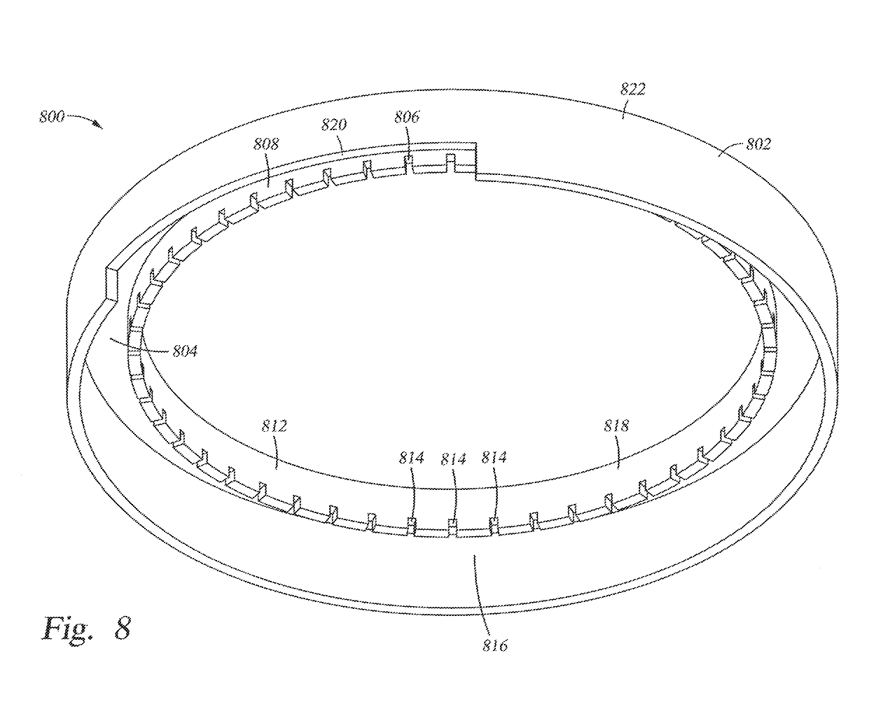

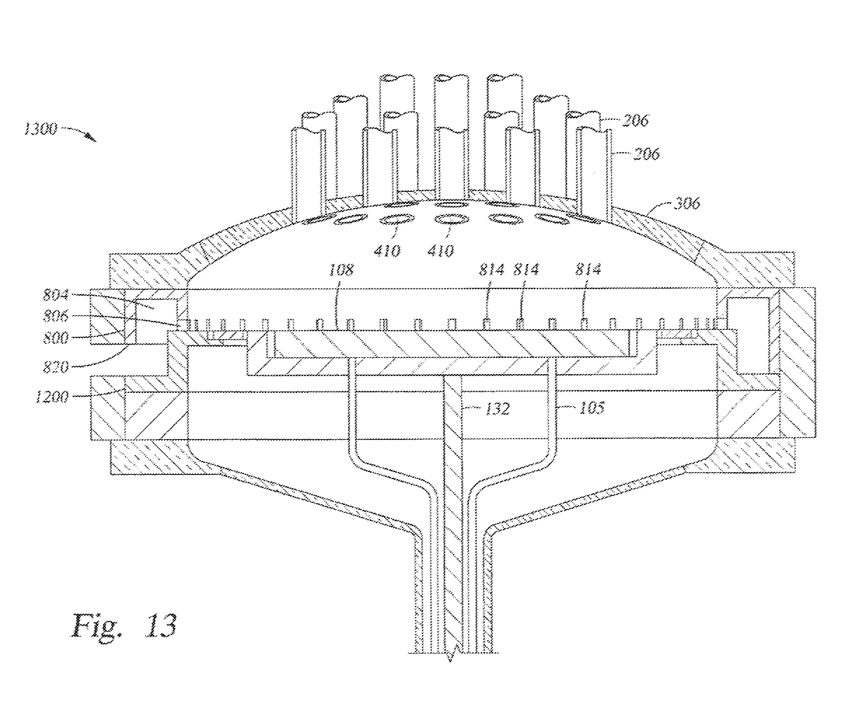

FIG. 8 illustrates a bottom perspective view of a perimeter pumping member 800, according to one embodiment. The perimeter pumping member 800 may be used as part of or a replacement for part of a liner assembly 163 illustrated in FIG. 1. FIG. 13 illustrates a portion of a processing chamber 1300 with a perimeter pumping member 800 installed.

In the embodiment illustrated in FIG. 8, the perimeter pumping member comprises a ring-shaped body 802, and may be formed from quartz or other materials compatible with processing in the chamber and the various process gases. The ring-shaped body may have a first curved channel 804 along an arc within the ring-shaped body, a first inner channel 806 connecting a first region 808 of the first curved channel to a first region of an inner surface 812 of the ring-shaped body, a plurality of second inner channels 814 connecting a second region 816 of the first curved channel to a second region 818 of the inner surface, and a first outer channel 820 connecting the first region of the first curved channel to an outer surface 822 of the ring-shaped body. The second inner channels may each be sized such that, when a fluid (e.g., a process gas or effluent gas) is pumped out of the first outer channel of the perimeter pumping member, the fluid flows through the first inner channel and the second inner channels at uniform flow rates. That is, when the perimeter pumping member is used in a process chamber, for example process chambers 100, 200, and 1300, fluids such as process gases and effluent gases may be pumped out of the first outer channel by a vacuum pump such as vacuum pump 180. The fluids reach the first outer channel via the first curved channel, and the fluids enter the first curved channel from the process chamber via the first and second inner channels. The second inner channels may be sized such that fluids flow through the first and second inner channels at uniform flow rates (e.g., a flow rate through any second inner channel is within +/−20% of the flow rate through the first inner channel). For example, the first inner channel may be sized such that gases flow through the first inner channel at a flow rate of about 400 standard cubic centimeters per minute (sccm) to about 1000 sccm, and the second inner channels may be sized such that gases flow through each second inner channel at a flow rate within 20% of the flow rate through the first inner channel. In a second example, the first inner channel may be sized such that gases flow through the first inner channel at a flow rate of about 480 sccm to about 760 sccm, and the second inner channels may be sized such that gases flow through each second inner channel at a flow rate within 10% of the flow rate through the first inner channel. In a third example, the first inner channel may be sized such that gases flow through the first inner channel at a flow rate of about 500 sccm to about 650 sccm, and the second inner channels may be sized such that gases flow through each second inner channel at a flow rate within 15% of the flow rate through the first inner channel.

While forty-two second inner channels are shown in FIG. 8, other numbers of second inner channels from three to sixty-three are contemplated. The first inner channel and second inner channels in FIG. 8 are shown as having rectangular cross-sections, but other shapes are contemplated.

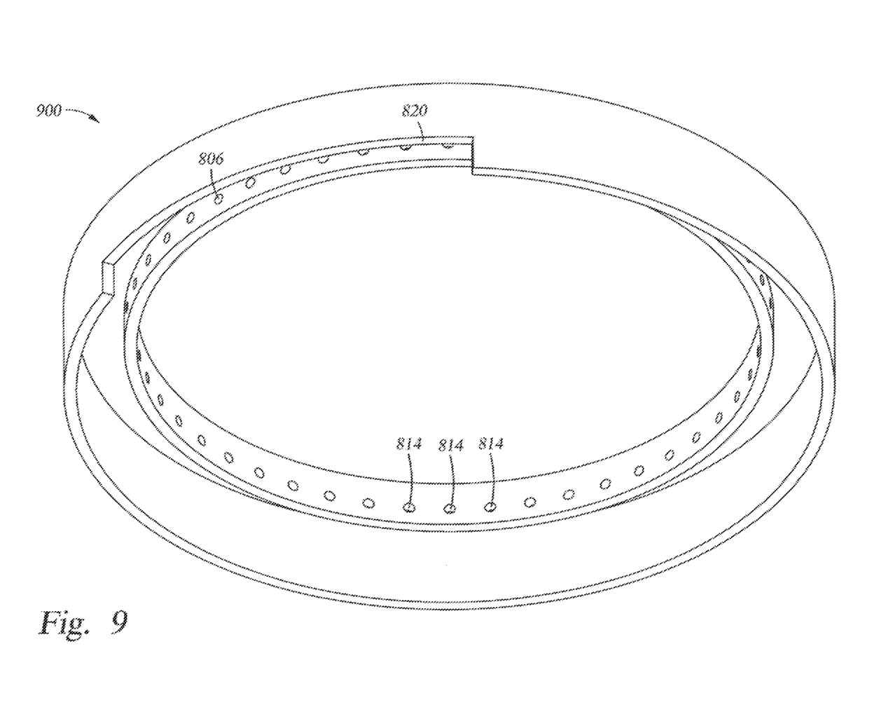

FIG. 9 illustrates a perspective view of a perimeter pumping member 900, according to one embodiment. Aspects of the perimeter pumping member that are similar to the perimeter pumping member illustrated in FIG. 8 have been discussed in greater detail above. In this embodiment, the first inner channel 806 and second inner channels 814 are shown as having circular cross-sections, but other shapes are contemplated. The second inner channels may each be sized such that, when a fluid (e.g., a process gas or effluent gas) is pumped out of the first outer channel 820 of the perimeter pumping member, the fluid flows through the first inner channel and the second inner channels at uniform flow rates (e.g., a flow rate through any second inner channel is within +/−20% of the flow rate through the first inner channel). That is, when the perimeter pumping member is used in a process chamber, for example process chambers 100, 200, and 1300, fluids such as process gases and effluent gases may be pumped out of the first outer channel by a vacuum pump such as vacuum pump 180. The fluids reach the first outer channel 820 via the first curved channel 804 (FIG. 8), and the fluids enter the first curved channel from the process chamber via the first and second inner channels. The second inner channels may be sized such that fluids flow through the first and second inner channels at uniform flow rates (e.g., a flow rate through any second inner channel is within +/−20% of the flow rate through the first inner channel). For example, the first inner channel may be sized such that gases flow through the first inner channel at a flow rate of about 400 sccm to about 1000 sccm, and the second inner channels may be sized such that gases flow through each second inner channel at a flow rate within 20% of the flow rate through the first inner channel. In a second example, the first inner channel may be sized such that gases flow through the first inner channel at a flow rate of about 480 sccm to about 760 sccm, and the second inner channels may be sized such that gases flow through each second inner channel at a flow rate within 10% of the flow rate through the first inner channel. In a third example, the first inner channel may be sized such that gases flow through the first inner channel at a flow rate of about 500 sccm to about 650 sccm, and the second inner channels may be sized such that gases flow through each second inner channel at a flow rate within 15% of the flow rate through the first inner channel. While thirty-seven second inner channels are shown in FIG. 9, other numbers of second inner channels from three to sixty-three are contemplated.

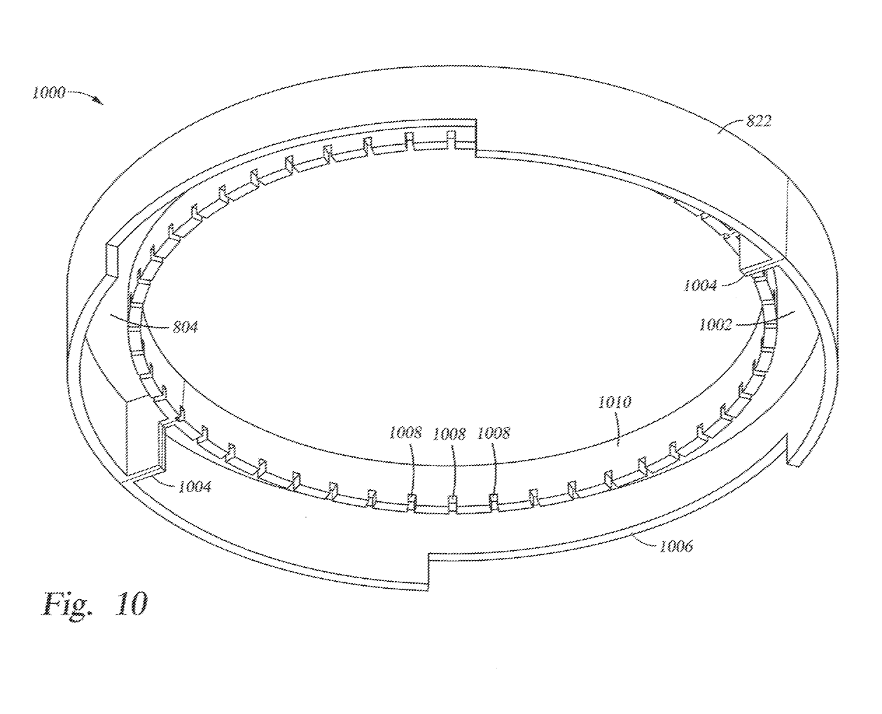

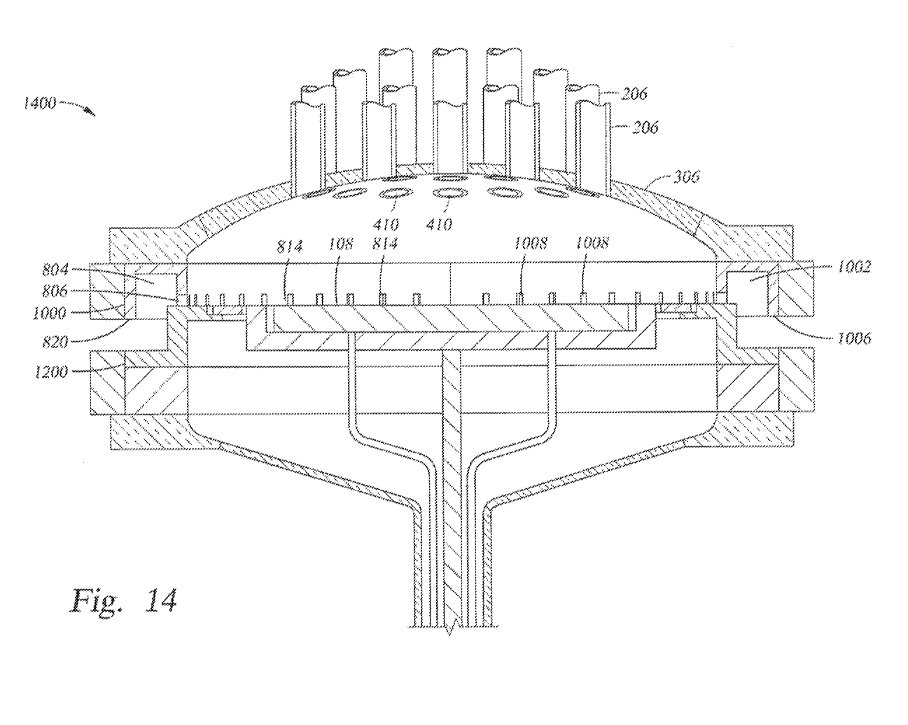

FIG. 10 illustrates a perspective view of a perimeter pumping member 1000, according to one embodiment. Aspects of the perimeter pumping member 1000 that are similar to the perimeter pumping member 800 in FIG. 8 have been discussed in greater detail above. The perimeter pumping member 1000 may be used as part of or a replacement for part of a liner assembly 163 illustrated in FIG. 1. The perimeter pumping member 1000 illustrated in FIG. 10 is shown as being made from two curved (e.g., semicircular or “horse-shoe” shaped) pieces, but it is contemplated that the member could be made from a plurality of curved pieces or as a single piece, similar to the perimeter pumping members 800 and 900 shown in FIGS. 8 and 9. FIG. 14 illustrates a portion of a processing chamber 1400 with a perimeter pumping member 1000 installed. The ring-shaped body may have a first curved channel 804 and a second curved channel 1002 along arcs within the ring-shaped body, one or more walls 1004 separating the first curved channel from the second curved channel, a plurality of third inner channels 1008 connecting the second curved channel to a third region 1010 of the inner surface, and a second outer channel 1006 connecting the second curved channel to the outer surface 822 of the ring-shaped body. The third inner channels may each be sized such that, when a fluid (e.g., a process gas or effluent gas) is pumped out of the first and second outer channels of the perimeter pumping member, the fluid flows through the first inner channel, the second inner channels, and the third inner channels at uniform flow rates. That is, when the perimeter pumping member 1000 is used in a process chamber, for example process chambers 100, 200, and 1400, fluids such as process gases and effluent gases may be pumped out of the first outer channel and the second outer channel by one or more vacuum pumps such as vacuum pump 180. The first and second outer channels lead to ports in the process chamber that are connected with exhaust tubes (not shown), which in turn are connected with the vacuum pump. The fluids reach the first outer channel and second outer channel via the first curved channel and the second curved channel, respectively. The fluids enter the first and second curved channels from the process chamber via the first, second, and third inner channels. As described above, the second inner channels may be sized such that fluids flow through the first and second inner channels at uniform flow rates. The third inner channels may also be sized such that fluids flow through the first and third inner channels at uniform flow rates. Thus, fluids may flow through the first, second, and third inner channels at uniform flow rates. For example, the first and second inner channels may be sized such that gases flow through them at uniform rates of about 400 sccm to about 1000 sccm, and the third inner channels may be sized such that gases flow through each third inner channel at a flow rate within 20% of the flow rate through the first inner channel and second inner channels. In a second example, the first inner channel and second inner channels may be sized such that gases flow through them at uniform rates of about 480 sccm to about 760 sccm, and the third inner channels may be sized such that gases flow through each third inner channel at a flow rate within 10% of the flow rate through the first inner channel and second inner channels. In a third example, the first inner channel and second inner channels may be sized such that gases flow through them at uniform rates of about 500 sccm to about 650 sccm, and the third inner channels may be sized such that gases flow through each third inner channel at a flow rate within 15% of the flow rate through the first inner channel and second inner channels.

While seventeen second inner channels are shown in FIG. 10, other numbers of second inner channels from two to thirty-one are contemplated. While twenty-two third inner channels are shown in FIG. 10, other numbers of third inner channels from three to thirty-one are contemplated. The first inner channel, second inner channels, and third inner channels are shown as having rectangular cross-sections in FIG. 10, but other shapes are contemplated.

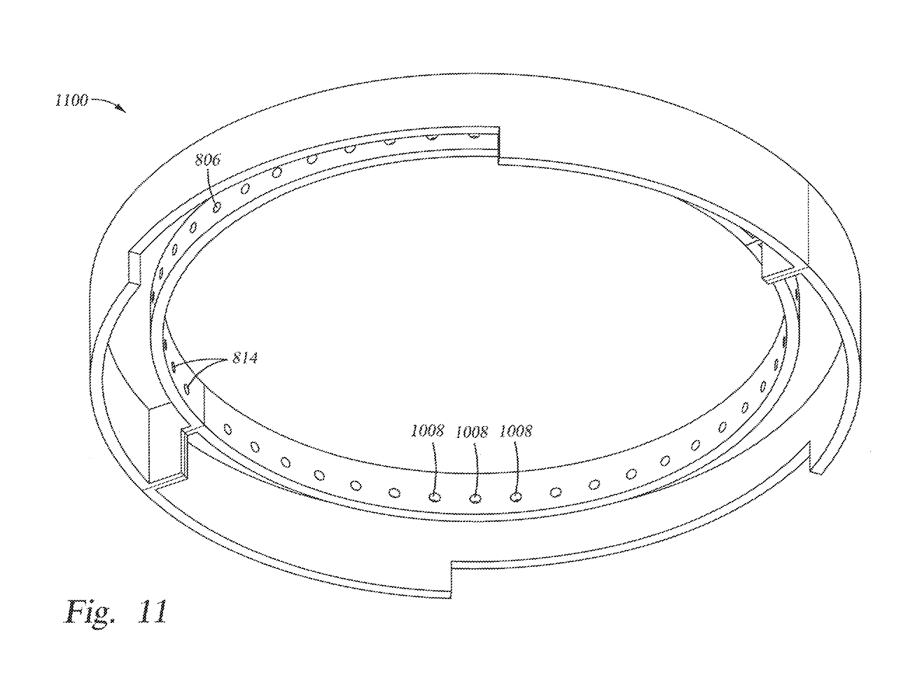

FIG. 11 illustrates a perspective view of a perimeter pumping member 1100, according to one embodiment. Aspects of the perimeter pumping member 1100 that are similar to the perimeter pumping members illustrated in FIGS. 8, 9, and 10 have been discussed in greater detail above. The perimeter pumping member 1100 illustrated in FIG. 11 is shown as being made from two curved (e.g., semicircular or “horse-shoe” shaped) pieces, but it is contemplated that the member could be made from a plurality of curved pieces or as a single piece, similar to the perimeter pumping members 800 and 900 shown in FIGS. 8 and 9. In this embodiment, the first inner channel 806, second inner channels 814, and third inner channels 1008 are shown as having circular cross-sections, but other shapes are contemplated. As described above, the second inner channels may be sized such that fluids flow through the first and second inner channels at uniform flow rates. The third inner channels may also be sized such that fluids flow through the first and third inner channels at uniform flow rates. Thus, fluids may flow through the first, second, and third inner channels at uniform flow rates. For example, the first and second inner channels may be sized such that gases flow through them at uniform rates of about 400 sccm to about 1000 sccm, and the third inner channels may be sized such that gases flow through each third inner channel at a flow rate within 20% of the flow rate through the first inner channel and second inner channels. In a second example, the first inner channel and second inner channels may be sized such that gases flow through them at uniform rates of about 480 sccm to about 760 sccm, and the third inner channels may be sized such that gases flow through each third inner channel at a flow rate within 15% of the flow rate through the first inner channel and second inner channels. In a third example, the first inner channel and second inner channels may be sized such that gases flow through them at uniform rates of about 500 sccm to about 650 sccm, and the third inner channels may be sized such that gases flow through each third inner channel at a flow rate within 10% of the flow rate through the first inner channel and second inner channels.

While fifteen second inner channels are shown in FIG. 11, other numbers of second inner channels from two to thirty-one are contemplated. While twenty third inner channels are shown in FIG. 11, other numbers of third inner channels from three to thirty-one are contemplated.

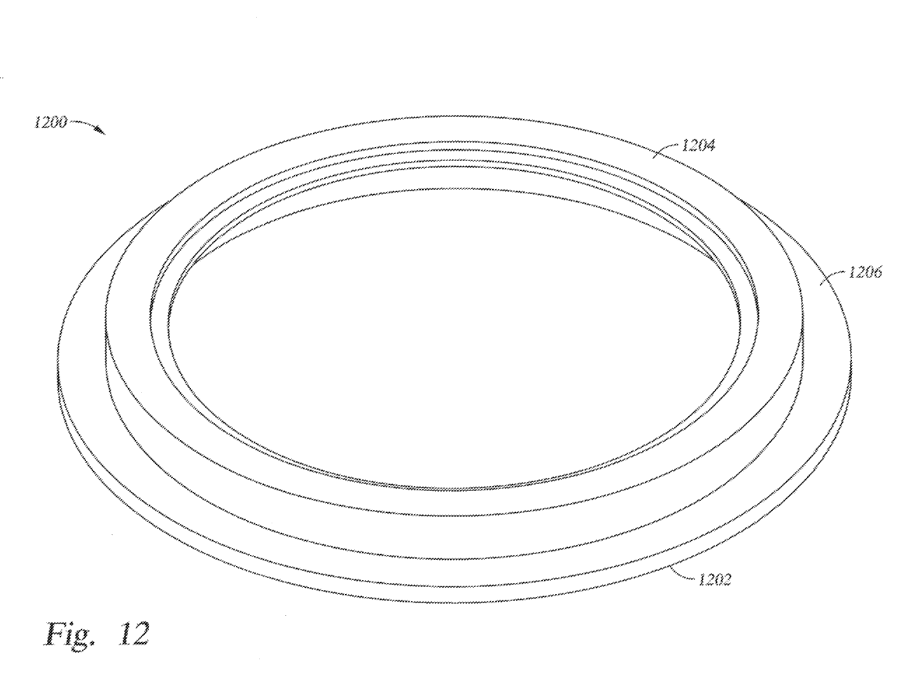

FIG. 12 illustrates a perspective view of a lower liner 1200, according to one embodiment. The lower liner 1200 may be used as part of or a replacement for part of a liner assembly 163 illustrated in FIG. 1. FIGS. 13 and 14 illustrate portions of processing chambers 1300 and 1400, each with a lower liner 1200 installed.

The lower liner 1200 comprises a ring-shaped body 1202, and may be formed from quartz or other materials compatible with processing in the chamber and the various process gases. The ring-shaped body has an inner upper surface 1204 and an outer upper surface 1206. When the lower liner is installed in a processing chamber with a perimeter pumping member 800, as illustrated in FIG. 13, the inner upper surface of the lower liner may abut the perimeter pumping member. When the lower liner is used with a perimeter pumping member 800, the lower liner may cover the lower sides of the first inner channel and second inner channels. The lower liner and perimeter pumping member may together form an inner surface of a liner assembly of a process chamber, with the first and second inner channels allowing fluids to exit the process volume.

When the lower liner is installed in a processing chamber with a perimeter pumping member 800, as illustrated in FIG. 13, the outer upper surface of the lower liner may also abut the perimeter pumping member and may cover the lower side of the first curved channel. The lower liner and perimeter pumping member may together form a toroidal channel having a rectangular cross-section, including the first curved channel of the perimeter pumping member. Fluids exiting the process volume via the first and second inner channels flow along the toroidal channel, and exit via the first outer channel of the perimeter pumping member.

When the lower liner is installed in a processing chamber with a perimeter pumping member 1000, as illustrated in FIG. 14, the inner upper surface of the lower liner may abut the perimeter pumping member and may cover the lower sides of the first inner channel, second inner channels, and third inner channels. The lower liner and perimeter pumping member may together form an inner surface of a liner assembly of a process chamber, with the first, second, and third inner channels allowing fluids to exit the process volume. The inner upper surface of the lower liner may also abut the perimeter pumping member at the walls 1004 separating the first and second curved channels of the perimeter pumping member (FIG. 10). When the lower liner is installed in a processing chamber with a perimeter pumping member 900, as illustrated in FIG. 14, the outer upper surface of the lower liner may also abut the perimeter pumping member.

When the lower liner is used with a perimeter pumping member 1000, the lower liner may cover the lower sides of the first and second curved channels. The lower liner and perimeter pumping member may together form two semi-toroidal channels having rectangular cross-section, each semi-toroidal channel including one of the first and second curved channels of the perimeter pumping member and being separated from the other semi-toroidal channel by the walls 1004 of the perimeter pumping member 1000 (FIG. 10). Fluids exiting the process volume via the first inner channel, second inner channels, and third inner channels flow along the rectangular semi-toroidal channels and exit via the first and second outer channels of the perimeter pumping member.

FIG. 13 illustrates a partial cross-sectional view of a processing chamber 1300 with a perimeter pumping member 800 and lower liner 1200 installed for use in processing, according to one embodiment. Aspects of the processing chamber 1300 which are similar to the chamber 100 of FIG. 1 and chamber 200 of FIG. 2 have been discussed in greater detail above. As depicted, the first clamp ring 101, second clamp ring 130, reflector plate 250, and lamp array 145 are not shown to allow a clearer view of the other components. During processing in process chamber 1300, process gases are supplied to the process chamber through gas delivery tubes 206 (See FIGS. 4A and 4B). While fifteen tubes 206 are depicted in FIG. 13, other numbers of tubes are contemplated, as described above. The process gases flow down to and across the upper surface of the substrate 108, reacting with the upper surface of the substrate. The process gases and effluent gases exit the process volume through the first inner channel 806 and second inner channels 814 of the perimeter pumping member.

As described above, the lower liner 1200 may abut the perimeter pumping member and, when used with a perimeter pumping member 800, closes lower sides of the first inner channel and second inner channels. Also as described above, the second inner channels may be sized such that the process gases and effluent gases flow through the first inner channel and second inner channels at uniform flow rates. It is believed that having the process gases and effluent gases exit the process volume at uniform flow rates and in radial directions improves uniformity of flow of the gases across the upper surface of the substrate and uniformity of the processing of the substrate. For example, uniformity of a deposited layer may be improved by having the process gases and effluent gases exit the process volume at uniform flow rates and in radial directions.

Upon exiting the process volume through the first inner channel 806 and second inner channels 814 of the perimeter pumping member, the process gases and effluent gases flow along the first curved channel 804 of the perimeter pumping member. As described above, the lower liner may abut the perimeter pumping member and may close the lower side of the curved channel, forming a toroidal channel. The process gases and effluent gases flow out of the first curved channel 804 through the first outer channel 820, due to the first outer channel aligning with one or more gas outlets (similar to the gas outlets 178 shown in FIG. 1) in the process chamber that are in turn connected with a vacuum pump (similar to vacuum pump 180 shown in FIG. 1), which pumps the process gases and effluent gases from the process chamber.

FIG. 14 illustrates a partial cross-sectional view of a processing chamber 1400 with a perimeter pumping member 1000 and lower liner 1200 installed for use in processing, according to one embodiment. Aspects of the processing chamber 1400 which are similar to the chamber 100 of FIG. 1 and chamber 200 of FIG. 2 have been discussed in greater detail above. As depicted, the first clamp ring 101, second clamp ring 130, reflector plate 250, and lamp array 145 are not shown to allow a clearer view of the other components. During processing in process chamber 1400, process gases are supplied to the process chamber through gas delivery tubes 206 (See FIGS. 4A and 4B). While fifteen tubes 206 are depicted in FIG. 14, other numbers of tubes are contemplated, as described above. The process gases flow down to and across the upper surface of the substrate 108, reacting with the upper surface of the substrate.

The process gases and effluent gases exit the process volume through the first inner channel 806, second inner channels 814, and third inner channels 1008 of the perimeter pumping member. As described above, the lower liner 1200 abuts the perimeter pumping member and, when used with a perimeter pumping member 1000, closes lower sides of the first inner channel, second inner channels, and third inner channels. Also as described above, the second inner channels and third inner channels are sized such that the process gases and effluent gases flow through the first inner channel, second inner channels, and third inner channels at uniform flow rates. It is believed that having the process gases and effluent gases exit the process volume at uniform flow rates and in radial directions improves uniformity of flow of the gases across the upper surface of the substrate and uniformity of the processing of the substrate. For example, uniformity of a deposited layer may be improved by having the process gases and effluent gases exit the process volume at uniform flow rates and in radial directions.

Upon exiting the process volume through the first inner channel 806 and second inner channels 814 of the perimeter pumping member, the process gases and effluent gases flow along the first curved channel 804 of the perimeter pumping member. Process gases and effluent gases exiting the process volume through the third inner channels 1008 flow along the second curved channel 1002. As described above, the lower liner abuts the perimeter pumping member and closes the lower side of the first curved channel and second curved channel, forming rectangular semi-toroidal passages.

The process gases and effluent gases flowing in the first curved channel 804 exit through the first outer channel 820, due to the first outer channel aligning with one or more gas outlets (similar to the gas outlet 178 shown in FIG. 1) in the process chamber which are in turn connected with a vacuum pump (similar to the vacuum pump 180 shown FIG. 1). The process gases and effluent gases flowing in the second curved channel 1002 exit through the second outer channel 1006, due to the second outer channel aligning with one or more gas outlets (similar to the gas outlet 178 shown in FIG. 1) in the process chamber which are in turn connected with a vacuum pump (similar to the vacuum pump 180 shown in FIG. 1), which pumps the process gases and effluent gases from the process chamber.

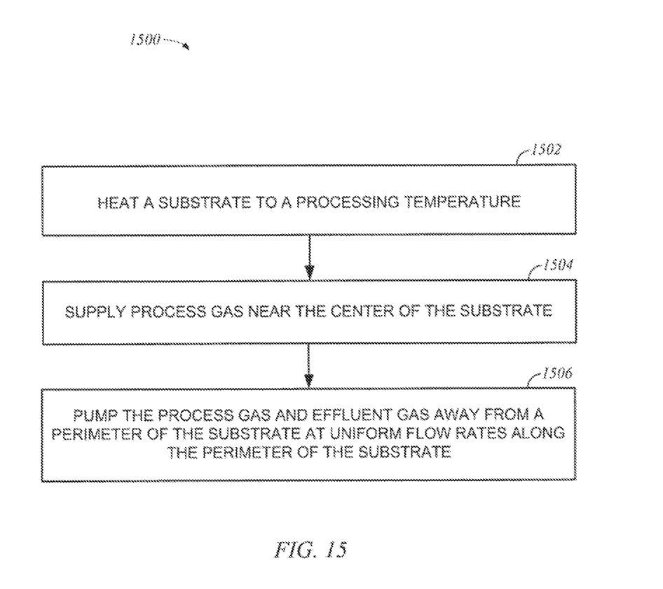

FIG. 15 sets forth an operation 1500 for processing substrates in a process chamber utilizing a perimeter pumping member, according to aspects of the present invention. The operation 1500 may be performed by an operator directing a controller in operating a process chamber (e.g., process chambers 1300 and 1400), or by a controller independently controlling a process chamber, for example.

Operation 1500 begins at 1502 by heating a substrate to a processing temperature. For example, a substrate located within one of the process chambers illustrated in FIGS. 13-14 may be heated by an array of lamps to a temperature range of 300-750° C., for example 350-500° C. or 400-450° C. The temperature of the substrate may be measured by one or more pyrometers, as described above with respect to FIG. 1, for example. An array of lamps (described above with respect to FIG. 1) may be controlled (e.g., by controlling a supply of electricity to the lamps) by one or more process controllers (e.g., a computer) to heat the substrate to the process temperature range and maintain the substrate's temperature within a desired range.

The operation 1500 continues at 1504 by supplying process gas from above the substrate. The process gas may, for example, comprise one or more precursor gases (e.g., Group III, Group IV, and Group V precursor gases) and an optional carrier gas. The process gas flows down and reacts with the substrate, possibly forming effluent gases.

At 1506, the operation 1500 continues by pumping the process gas and effluent gas away from a perimeter of the substrate at uniform flow rates along the perimeter of the substrate. The effluent gas and any unreacted process gas may be pumped out of a process chamber (e.g., the process chambers in FIGS. 13-14) via inner channels of a perimeter pumping member, as described in FIGS. 8-11, for example. The effluent gas and process gas may, for example, flow along curved channels within a perimeter pumping member and lower liner, as described above with respect to FIGS. 8-12. The effluent gas and process gas may, for example, exit the curved channels through one or more outer channels, being pumped away from the process chamber by one or more vacuum pumps, as described above with respect to FIG. 1. As described above, pumping the effluent and process gas away from the perimeter of the substrate at uniform flow rates along the perimeter may improve uniformity of the processing of the substrate.

While the foregoing is directed to embodiments of the present invention, other and further embodiments of the invention may be devised without departing from the basic scope thereof, and the scope thereof is determined by the claims that follow.

1. A perimeter pumping member, comprising:
a ring-shaped body having a first curved channel along an arc within the ring-shaped body, a first inner channel connecting a first region of the first curved channel to a first region of an inner surface of the ring-shaped body, a plurality of second inner channels connecting a second region of the first curved channel to a second region of the inner surface, and a first outer channel connecting the first region of the first curved channel to an outer surface of the ring-shaped body, wherein the second inner channels are each sized such that, when a fluid is pumped out of the perimeter pumping member via the first outer channel, the fluid flows through the first inner channel and the second inner channels at a uniform flow rate.

2. The perimeter pumping member of claim 1, wherein an axis of the first inner channel and an axis of each of the plurality of second inner channels are each parallel to a corresponding radius of the perimeter pumping member.

3. The perimeter pumping member of claim 1, wherein the perimeter pumping member further comprises quartz.

4. The perimeter pumping member of claim 1, wherein the first inner channel and second inner channels have rectangular cross-sections.

5. The perimeter pumping member of claim 1, wherein the first inner channel and second inner channels have circular cross-sections.

6. The perimeter pumping member of claim 1, wherein the ring-shaped body further has:
a second curved channel along an arc within the ring-shaped body;
one or more walls separating the first curved channel from the second curved channel;
a second outer channel connecting the second curved channel to the outer surface of the ring-shaped body; and
a plurality of third inner channels connecting the second curved channel to a third region of the inner surface, wherein the third inner channels are each sized such that, when a fluid is pumped out of the pumping ring via the first and second outer channels, the fluid flows through the first inner channel, second inner channels, and the third inner channels at a uniform flow rate.

7. The perimeter pumping ring of claim 6, wherein the ring-shaped body comprises a plurality of curved pieces.

8. An apparatus for processing a substrate, comprising:
a processing chamber body;
a divider coupled to the chamber body;
one or more holes formed through the divider;
one or more conduits, each having a first end and a second end, the first end coupled to the divider, each conduit extending from one of the one or more holes;
a flange coupled to the second end of each of the one or more conduits; and
a perimeter pumping member comprising a ring-shaped body having a first curved channel along an arc within the ring-shaped body, a first inner channel connecting a first region of the first curved channel to a first region of an inner surface of the ring-shaped body, a plurality of second inner channels connecting a second region of the first curved channel to a second region of the inner surface of the ring-shaped body, and a first outer channel connecting the first region of the first curved channel to an outer surface of the ring-shaped body, wherein the second inner channels are each sized such that, when a fluid is pumped out of the perimeter pumping member via the first outer channel, the fluid flows through the first inner channel and the second inner channels at a uniform flow rate.

9. The apparatus of claim 8, further comprising a reflector plate coupled to the chamber body, the reflector plate disposed between the divider and the flange.

10. The apparatus of claim 8, further comprising a pump connected to pump fluids out of the first outer channel of the perimeter pumping member.

11. The apparatus of claim 8, further comprising a lower liner, wherein the lower liner comprises:
a ring-shaped body having an inner upper surface that abuts the perimeter pumping member and covers a lower side of the first inner channel and lower sides of the second inner channels of the perimeter pumping member.

12. The apparatus of claim 11, wherein the ring-shaped body comprises quartz.

13. The apparatus of claim 11, wherein the lower liner further comprises an outer upper surface that abuts the perimeter pumping member and covers a lower side of the first curved channel.

14. The apparatus of claim 8, wherein the ring-shaped body of the perimeter pumping member further has:
a second curved channel along an arc within the ring-shaped body;
one or more walls separating the first curved channel from the second curved channel;
a second outer channel connecting the second curved channel to the outer surface of the ring-shaped body; and
a plurality of third inner channels connecting the second curved channel to a third region of the inner surface, wherein the third inner channels are each sized such that, when a fluid is pumped out of the perimeter pumping member via the first and second outer channels, the fluid flows through the first inner channel, second inner channels and the third inner channels at a uniform flow rate.

15. The apparatus of claim 14, further comprising a pump connected to pump fluids out of the first outer channel and the second outer channel of the perimeter pumping member.

16. The apparatus of claim 14, wherein the ring-shaped body of the perimeter pumping ring comprises a plurality of curved pieces.

17. The apparatus of claim 16, further comprising a pump connected to pump fluids out of the first outer channel and the second outer channel of the perimeter pumping member.

18. An apparatus for processing a substrate, comprising:
a processing chamber body;
a first quartz divider coupled to the chamber body;
a second quartz divider coupled to the chamber body opposite the first quartz divider, the chamber body, first quartz divider, and second quartz divider defining a processing volume;
a substrate support disposed within the processing volume;
a lamp array coupled to the chamber body outside the processing volume;
one or more holes formed through the second quartz divider;
a conduit coupled to each of the one or more holes and extending from each hole away from the processing volume;
a flange coupled to each conduit; and
a perimeter pumping member coupled within the chamber body, the perimeter pumping member comprising:
a ring-shaped body having a first curved channel along an arc within the ring-shaped body, a first inner channel connecting a first region of the first curved channel to a first region of an inner surface of the ring-shaped body, a plurality of second inner channels connecting a second region of the first curved channel to a second region of the inner surface, and a first outer channel connecting the first region of the first curved channel to an outer surface of the ring-shaped body, wherein the second inner channels are each sized such that, when a fluid is pumped out of the perimeter pumping member via the first outer channel, the fluid flows through the first inner channel and the second inner channels at a uniform flow rate.

19. The apparatus of claim 18, further comprising a lower liner, wherein the lower liner comprises:
a ring-shaped body having an inner upper surface that abuts the perimeter pumping member and covers a lower side of the first inner channel and lower sides of the second inner channels of the perimeter pumping member.

20. The apparatus of claim 18, wherein the ring-shaped body of the perimeter pumping member further has:
a second curved channel along an arc within the ring-shaped body;
one or more walls separating the first curved channel from the second curved channel;
a second outer channel connecting the second curved channel to the outer surface of the ring-shaped body; and
a plurality of third inner channels connecting the second curved channel to a third region of the inner surface, wherein the third inner channels are each sized such that, when a fluid is pumped out of the perimeter pumping member via the first and second outer channels, the fluid flows through the first inner channel, second inner channels, and the third inner channels at a uniform flow rate.
